(19) United States
(12) Patent Application Publication
(10) Pub. No.: US 2016/0213000 A1
(43) Pub. Date: Jul. 28, 2016

(54) Method for Controlling Weeds in Sugar Cane Plantations

(71) Applicants: BASF AGROCHEMICAL PRODUCTS B.V., EA Arnhem (NL); UNIVERSIDADE ESTADUAL DE MARINGÁ / CENTRO DE CIENCIAS AGRARIAS / DEPATAMENTO DE AGRONOMIA, Maringa (BR)

(72) Inventors: Mariano Ignacio ETCHEVERRY, Mannheim (DE); Frank RUNGE, Neustadt an der Weinstrasse (DE); Paulo Cesar QUEIROZ, Sao Paulo (BR); Lucelena Patricio CARDOSO, Guaratingueta (BR); Jamil CONSTANTIN, Maringa (BR); Gilberto VELHO, Sao Paulo (BR); Lucio de Paula COLLETTE, Ribeirao Preto (BR); Fredy MARISCAL, Buenos Aires City (AR)

(21) Appl. No.: 15/024,462

(22) PCT Filed: Sep. 23, 2014
(86) PCT No.: PCT/EP2014/070277

§ 371 Date: Mar. 24, 2016

Related U.S. Application Data
(60) Provisional application No. 61/882,644, filed on Sep. 26, 2013.

(30) Foreign Application Priority Data
Nov. 4, 2013 (EP) 13191335.2

(51) Int. Cl. A01N 43/82; A01N 43/66; C05G 3/02; A01N 43/80; A01N 41/10; C05C 9/00; A01N 43/50; A01N 43/653

(52) U.S. Cl. CPC A01N 43/82; A01N 43/50; A01N 43/66; A01N 43/653; A01N 43/80; A01N 41/10; C05C 9/00; C05G 3/02

(57) ABSTRACT

Methods for controlling weeds in sugar cane plantations, wherein at least one herbicide (A) is applied as solid agrochemical formulation (B) to the plantation; and solid agrochemical formulations (B), which are dry, ready for use granules, comprising at least one herbicide (A) selected from metribuzin, diuron, bentazone, hexazinone, tebuthiuron, sulfentrazone, imazapic, imazapyr, glyphosate, MSMA, ametryn, clomazone, isoxaflutole, mesotrione, amicarbazone, atrazine, paraquat, 2,4-D, pendimethalin, saflufenacil and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) and at least one carrier (C) selected from the groups (C1) to (C7):
(C1) organic based materials (botanicals);
(C2) fertilizers;
(C3) clays;
(C4) carbonates;
(C5) sulfates;
(C6) synthetic of synthetically modified minerals;
(C7) synthetic polymers, polymer dispersions and superabsorbent polymers.

The present invention relates to methods for controlling weeds in sugar cane plantations as well as to solid herbicidal formulations and their use for weed control in sugar cane plantations.

Sugar cane usually is planted in furrows open in the soil, where a stem cutting of sugarcane having a specific length is distributed. A stem cutting, a section of stalk from mature plants, is a piece to propagate sugar cane. Nodes with buds on the stem cutting are responsible for the emergence of the sugar cane. Node means the part of the stalk, where a bud and root primordia are found.

The stem cutting has up to 3 buds and it is regularly treated with fungicides and/or insecticides that are sprayed over the top. After the distribution of the stem cuttings in the furrows and their treatment with fungicides and/or and insecticides, the furrow is sealed with soil.

Following, weed control generally is effected with pre-emergence herbicides, being applied before the emergence of the weeds. Mixture of different herbicides also is possible in case control of already emerged weeds is indicated, the burn down of the emerged weeds, being more effective.

Between 60 and 120 days after distribution of the stem cuttings, a further application of a residual herbicide is often indicated, protecting the sugar cane until the leaves form a canopy.

Sugar cane usually is harvested between one year or one year and a half after planting, depending on the variety, soil and climate conditions.

After the harvest, ratooning can be practiced. Ratooning is a method of cultivating a crop, in particular sugar cane, which, after cutting (harvest), leaves the roots and the lower parts of the plant uncut to give the ratoon. The stalks, i.e. the harvested part, are used for sugar production. The ratoon or stubble crop remaining in the field has buds with nodes, from which new leaves emerge in time.

Presently, weed control in sugar cane plantations is time consuming and laborious, as the application of a herbicide requires a separate step from planting stem cuttings and harvest.

WO2010/089208 describes for example a method of controlling weed in a sugar cane field, comprising applying one or more PPO-inhibiting compounds to a field before, at or after planting with a stem cutting of sugar cane having only one node.

It is therefore an object of the present invention providing a method for controlling weeds in sugar cane plantations, which is more efficient than commonly practiced methods.

It is another object of the present invention providing an agrochemical formulation allowing for a more efficient weed control in sugar cane.

The methods and compositions according to the invention shall provide for efficient weed control in sugar cane plantations without causing unacceptable phytotoxicity to the crop.

Furthermore, the methods and compositions according to the invention shall provide for increased yield of the crop and produced cane sugar.

These and further objectives are achieved by the methods and agrochemical formulations defined below.

It has been found that the above objectives can be achieved by applying at least one herbicide (A) as solid agrochemical formulation (B) to the sugar cane plantation.

Therefore, in a first aspect, the present invention relates to a method for controlling weeds in sugar cane plantations, wherein at least one herbicide (A) is applied as solid agrochemical formulation (B) to the plantation.

In a second aspect, the present invention relates to a solid agrochemical formulation (B), which is a dry, ready for use granule, comprising at least one herbicide (A) selected from metribuzin, diuron, bentazone, hexazinone, tebuthiuron, sulfentrazone, imazapic, imazapyr, glyphosate, MSMA, ametryn, clomazone, isoxaflutole, mesotrione, amicarbazone, atrazine, paraquat, 2,4-D, pendimethalin, saflufenacil and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) and at least one carrier (C) selected from the groups (C1) to (C7):
(C1) organic based materials (botanicals)*;
(C2) fertilizers;
(C3) clays;
(C4) carbonates;
(C5) sulfates;
(C6) synthetic of synthetically modified minerals;
(C7) synthetic polymers, polymer dispersions and superabsorbent polymers.
In the context of the present invention, “organic based materials” (botanicals) means “plant materials”, e.g. cellulose based carriers, corn cob grits, rice hulls and coconut shells.

According to one embodiment of the invention, the agrochemical formulation (B) is applied at the time of harvest of the sugar cane.

In the context of the present application, time of harvest means before cutting of the sugar cane stems, simultaneously with the cutting of the sugar cane stems or after the cutting of the sugar cane stems.

According to a preferred embodiment of the invention, the agrochemical formulation (B) is applied simultaneously with the cutting of the sugar cane stems.

According to another preferred embodiment of the invention, the agrochemical formulation (B) is applied after the cutting of the sugar cane stems, preferably up to the emergence of 10 to 12 leaves from the ratoons.

According to a more preferred embodiment of the invention, the agrochemical formulation (B) is applied after the cutting of the sugar cane stems, preferably up to the emergence of 4 leaves from the ratoons.

The farmer has several suitable options for practicing the inventive method:
a. pre-emergence of the new ratoon cane and over the top of the straw from sugar cane;
b. pre-emergence of the new ratoon cane and under the straw from sugar cane;
c. pre-emergence of the new ratoon cane and without the straw from sugar cane;
d. post-emergence of the new ratoon cane and over the top of straw from sugar cane, preferably up to the emergence of 10 to 12 leaves from the ratoons;
e. post-emergence of the new ratoon cane and without straw of the sugar cane, preferably up to the emergence of 10 to 12 leaves from the ratoons;

The solid agrochemical formulation (B), which is used in the inventive method, comprises at least one herbicide (A), which is selected from the following groups (A1) to (A9):
(A1) imidazolinones selected from imazamox, imazapic, imazapyr, imazaquin and imazethapyr;
(A2) PPO inhibitors selected from saflufenacil, sulfentrazone, flumioxazin, fomesafen, oxadiazon, oxyfluorfen, carfentrazone-ethyl and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4);
(A3) bleacher herbicides selected from isoxaflutole, topramezone, mesotrione, fenquintrione, bicyclopyrone and clomazone;
(A4) photosynthesis inhibitors selected from atrazine, ametryn, terbutryn, simazine, terbutylazine, bentazone, hexazinone, amicarbazone, metribuzin, bromacil, ioxynil, tebuthiuron, diuron, linuron, isouron, diquat and paraquat;
(A5) auxin herbicides selected from 2,4-D, 2,4-DB, MCPA, picloram, dicamba, triclopyr, fluroxypyr, halauxifen and aminopyralid;
(A6) VLCFA inhibitors selected from metolachlor, (S)-metolachlor, dimethenamide, dimethenamide-P, acetochlor, alachlor and pyroxasulfone;
(A7) sulfonylurea herbicides selected from ethoxysulfuron, trifloxysulfuron, sulfometuron, metsulfuron, halosulfuron, iodosulfuron and chlorimuron;
(A8) ACCase inhibitors selected from clethodim, cycloxydim, sethoxydim, profoxydim, tepraloxydim, fluazifop, fluazifop-P, haloxyfop and haloxyfop-P;
(A9) other herbicides such as glyphosate, glufosinate, pendimethalin, trifluralin, diclosulam, asulam, MSMA, TCA and indaziflam;
and the agronomically suitable salts, amides and esters of the herbicides (A1), (A2), (A3), (A4), (A5), (A6), (A7), (A8) and (A9).

In one embodiment of the invention, the solid agrochemical formulation (B) comprises at least one herbicide (A), which is selected from hexazinone, tebuthiuron, sulfentrazone, imazapic, isoxaflutole and mesotrione.

According to a preferred embodiment, the solid agrochemical formulation (B) comprises at least one herbicide (A), which is selected from metribuzin, diuron, bentazone, hexazinone, tebuthiuron, sulfentrazone, imazapic, imazapyr, glyphosate, MSMA, ametryn, clomazone, isoxaflutole, mesotrione, amicarbazone, atrazine, paraquat, 2,4-D, pendimethalin, saflufenacil and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4).

According to a second preferred embodiment, the solid agrochemical formulation (B) comprises as herbicide (A) imazapic.

According to a third preferred embodiment, the solid agrochemical formulation (B) comprises as herbicide (A) a mixture of imazapic and hexazinone.

According to a fourth preferred embodiment, the solid agrochemical formulation (B) comprises as herbicide (A) a mixture of imazapic and saflufenacil.

According to a fifth preferred embodiment, the solid agrochemical formulation (B) comprises as herbicide (A) a mixture of imazapic, hexazinone and saflufenacil.

In the context of the present invention the agrochemical formulation (B) comprises 0.1 to 50% (w/w) of at least one herbicide (A), preferably 0.1 to 25% (w/w) of at least one herbicide (A).

Generally, any solid agrochemical formulation (B), which is ready for use, is suitable in the method according to the present invention.

“Ready for use” in the context of the present invention means that the solid agrochemical formulation (B) is applied to the sugar cane plantation directly as a solid, without prior dilution in water and/or organic solvents.

Preferably, the agrochemical formulation (B) allows for a high quality, even distribution of the herbicide (A) in the plantation and thus for consistent weed control and crop safety.

Suitable formulation types (B) are (B1) to (B3):
(B1) tablet for direct application (DT),
(B2) granule (GR) and
(B3) tablet (TB).

The classification of the formulation types (B1) to (B3) above is in accordance with the “Catalogue of pesticide formulation types and international coding system” in Technical Monograph no 2, 6^{th} Edition, revised May 2008, by CropLife International. Following this publication, the formulation code GR includes the historical, obsolete formulation codes MG (microgranule=GR in the particle size range 0.1-0.6 mm), FG (fine granule=GR in the particle size range 0.3-2.5 mm) and CG (encapsulated granule=GR with a protective or granule release-controlling coating).

According to a preferred embodiment, the solid agrochemical formulation (B) is a granular formulation ((GR), (B2)) as for example described in “New developments in crop protection product formulation” by Alan Knowles, in Agrow Reports 2005, chapter 2.2.

In one embodiment of the invention, the agrochemical formulation (B) comprises an inert carrier (C).

Suitable inert carriers (C) are solids such as mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, methylcellulose, starch; fertilizers, e.g. ammonium sulfate, ammonium phosphate, ammonium nitrate, ureas; products of vegetable origin, e.g. cereal meal, tree bark meal, wood meal, nutshell meal; sugars, e.g. mono- or disaccharides; and mixtures thereof.

In the context of the present invention, suitable carriers (C) are for example selected from the groups (C1) to (C7):
(C1) organic based materials (botanicals);
(C2) fertilizers;
(C3) clays;
(C4) carbonates;
(C5) sulfates;
(C6) synthetic of synthetically modified minerals;
(C7) synthetic polymers, polymer dispersions and superabsorbent polymers.

Preferred carriers (C) are selected from
(C1) organic based materials (botanicals): cellulose based carriers, corn cob grits, rice hulls and coconut shells;
(C2) fertilizers: urea, potassium nitrate, ammonium carbonate, K—N—P fertilizer mixtures, ammonium nitrate;
(C3) clays: china clay, attapulgite, kaolin, montmorillonite, talc, diatomites;
(C4) carbonates: calcite, dolomite, limestone;
(C5) sulfates: gypsum;
(C6) synthetic of synthetically modified minerals: precipitated silica, fumed silica, hydrophobically modified silica and combinations thereof;
(C7) synthetic polymers, polymer dispersions and superabsorbent polymers: polyvinylpyrrolidone, polyvinylalkohol, polyvinylacetat, carboxylate copolymers, cross-linked polymer granules.

Examples for cellulose based carriers (C1) are mixtures of paper fiber, kaolin clay, calcium carbonate and optionally titanium dioxide, commercially available as Biodac® from Kadant.

Examples for fertilizers (C2) are Ureia Fertilizante (Petrobras, Brasil), Fertilizante Heringer Sulfato de Amonio, Fertilizante Heringer Sulfato de Potassio, Fertilizante Heringer Cloreto de Potassio, Fertilizante Heringer Superfosfato Simples, Fertilizante Heringer Ureia, Fertilizante Heringer NPK (Heringer, Brasil).

Examples for clays (C3) are ASP® (BASF), Satintone® (BASF), Liteball® 14/40 (Curimbaba, Brasil), Agsorb® (Ripley, USA).

Examples for carbonates (C4) are Calcium Carbonate/Limestone (Franklin Minerals, USA).

Examples for sulfates (C5) are Gypsum Dyrwall (Etex, Brasil).

Examples for synthetic of synthetically modified minerals (C6) are Sipernat® (Evonik). Examples for synthetic polymers, polymer dispersions and superabsorbent polymers (C7) are Aquasorb® (Chemtall, USA), CarboSil® (DSM, Netherlands).

In the context of the present invention, the agrochemical formulation (B) preferably comprises a carrier with a particle size distribution of 4 to 50 mesh (equivalent sieve size 4.76 mm-0.30 mm), more preferably, a particle size distribution of 20 to 50 mesh (equivalent sieve size 0.84 mm-0.30 mm).

In one embodiment, the agrochemical formulation (B) comprises a clay based carrier (C3), for example china clay, attapulgite, kaolin, montmorillonite, talc and diatomites, preferably with a particle size distribution of 4 to 50 mesh, more preferably with a particle size distribution of 20 to 50 mesh.

In another embodiment, the agrochemical formulation (B) comprises a cellulose based carrier (C1), for example a mixture of paper fiber, kaolin clay, calcium carbonate and optionally titanium dioxide, preferably with a particle size distribution of 4 to 50 mesh, more preferably with a particle size distribution of 20 to 50 mesh.

In a preferred embodiment, the agrochemical formulation (B) comprises as herbicide (A) imazapic and a clay based carrier (C3), for example china clay, attapulgite, kaolin, montmorillonite, talc and diatomites, preferably with a particle size distribution of 4 to 50 mesh, more preferably with a particle size distribution of 20 to 50 mesh.

In another preferred embodiment, the agrochemical formulation (B) comprises as herbicide (A) a mixture of imazapic and hexazinone and a clay based carrier (C3), for example china clay, attapulgite, kaolin, montmorillonite, talc and diatomites, preferably with a particle size distribution of 4 to 50 mesh, more preferably with a particle size distribution of 20 to 50 mesh.

In another preferred embodiment, the agrochemical formulation (B) comprises as herbicide (A) a mixture of imazapic and saflufenacil and a clay based carrier (C3), for example china clay, attapulgite, kaolin, montmorillonite, talc and diatomites, preferably with a particle size distribution of 4 to 50 mesh, more preferably with a particle size distribution of 20 to 50 mesh.

In another preferred embodiment, the agrochemical formulation (B) comprises as herbicide (A) a mixture of imazapic, hexazinone and saflufenacil and a clay based carrier (C3), for example china clay, attapulgite, kaolin, montmorillonite, talc and diatomites, preferably with a particle size distribution of 4 to 50 mesh, more preferably with a particle size distribution of 20 to 50 mesh.

In another preferred embodiment, the agrochemical formulation (B) comprises as herbicide (A) imazapic and a cellulose based carrier (C1), for example a mixture of paper fiber, kaolin clay, calcium carbonate and optionally titanium dioxide, preferably with a particle size distribution of 4 to 50 mesh, more preferably with a particle size distribution of 20 to 50 mesh.

In another preferred embodiment, the agrochemical formulation (B) comprises as herbicide (A) a mixture of imazapic and hexazinone and a cellulose based carrier (C1), for example a mixture of paper fiber, kaolin clay, calcium carbonate and optionally titanium dioxide, preferably with a particle size distribution of 4 to 50 mesh, more preferably with a particle size distribution of 20 to 50 mesh.

In another preferred embodiment, the agrochemical formulation (B) comprises as herbicide (A) a mixture of imazapic and saflufenacil and a cellulose based carrier (C1), for example a mixture of paper fiber, kaolin clay, calcium carbonate and optionally titanium dioxide, preferably with a particle size distribution of 4 to 50 mesh, more preferably with a particle size distribution of 20 to 50 mesh.

In another preferred embodiment, the agrochemical formulation (B) comprises as herbicide (A) a mixture of imazapic, hexazinone and saflufenacil and a cellulose based carrier (C1), for example a mixture of paper fiber, kaolin clay, calcium carbonate and optionally titanium dioxide, preferably with a particle size distribution of 4 to 50 mesh, more preferably with a particle size distribution of 20 to 50 mesh.

The agrochemical formulation (B) according to the present invention may further comprise fertilizers and agrochemical auxiliaries.

A fertilizer is any material, organic or inorganic, natural or synthetic, that supplies plants with the necessary nutrients for plant growth and optimum yield. Suitable inorganic fertilizers are nitrogen, phosphorous or potassium fertilizers such as sodium nitrate, ammonium nitrate, ammonium sulfate, potassium sulfate, ammonium phosphate, potassium chloride, ureas and mixtures thereof. Suitable organic fertilizers are natural materials of either plant or animal origin, including livestock manure, green manures, crop residues, household waste, compost, woodland litter and mixtures thereof.

Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers, binders and coating agents.

In the context of the present invention, auxiliaries suitable for binding and coating the agrochemical formulation (B) are particularly useful.

Suitable binders and coating agents are: Commercially available polyesters, polyamides, polycarbonates, polyurea and polyurethanes, acrylate polymers and copolymers, styrene copolymers, butadiene copolymers, polysaccharides such as starch and cellulose derivatives, vinylalcohol, vinylacetate and vinylpyrrolidone polymers and copolymers, polyethers, epoxy, phenolic and melamine resins polyolefins and olefine copolymers and mixtures thereof. Examples of preferred polymers are acrylate polymers such as poly(methacrylate), poly(ethyl methacrylate), poly(methylmethacrylate), acrylate copolymers and styrene-acrylic copolymers, poly(styrene-co maleic anhydride), cellulosic polymers such as ethyl cellulose, cellulose acetate, cellulose acetatebutyrate, acetylated mono-, di-, and triglycerides, poly(vinylpyrrolidone), vinyl acetate polymers and copolymers, poly(alkylene glycol), styrene butadiene copolymers, poly(orthoesters), alkyd resins, and mixtures of two or more of these. Polymers that are biodegradable are also useful in the present invention. As used herein, a polymer is biodegradable if is not water soluble, but is degraded over a period of several weeks when placed in an application environment. Examples of biodegradable polymers that are useful in the present method include biodegradable polyesters, starch, polylactic acid-starch blends, polylactic acid, poly(lactic acid-glycolic acid) copolymers, polydioxanone, cellulose esters, ethyl cellulose, cellulose acetate butyrate, starch esters, starch ester-aliphatic polyester blends, modified corn starch, polycaprolactone, poly(n-amylmethacrylate), wood rosin, polyanhydrides, polyvinylalcohol, polyhydroxybutyrate-valerate, biodegradable aliphatic polyesters, and polyhydroxybutyrate.

Examples for binders and coating agents are Acrodur®, Acronal®, AQAGloss®, Basonal®, COL.9®, Elastan®, Glascol®, Joncryl®, Kollidon®, Kollicoat®, Lepton®, Luhydran®, Poloxamer®, Styrofan®, Styronal® dispersions by BASF.

Subject matter of the present invention hence is also an agrochemical formulation (B) as defined above, comprising an acrylate polymer based coating.

The agrochemical formulation (B) according to the present invention may further comprise other herbicides and/or herbicide safeners or other crop protection agents, for example virucides, bactericides, nematicides, algaecides, fungicides, plant activators, growth regulators, molluscicides, insect attractants, insect repellants, insecticides, ectoparasiticides/acaricides, piscicides, avicides, bird repellents, mammal repellents, rodenticides or mating disrupters.

Generally, the agrochemical formulations (B) according to the present invention can be prepared as follows:
(B1) tablet for direct application (DT):
Tablets for direct application (B1) are prepared in the same manner as tablets (B3). Tablets are prepared by compression of a wet paste/slurry or a dry powder and/or granular mixture in a compactor or a tablet press as described in “New developments in crop protection product formulation” by Alan Knowles, in Agrow Reports 2005, chapter 6.5. The tableting process used in this invention is identical to the general processes used in the pharmaceutical area as described for example in http://pharmatips.doyouknow.in/Articles/Tablet-Manufacturing-Process.aspx
A herbicide (A) is mixed with auxiliaries, for example binders, flow aids, lubricants, dispersing agents and fillers/disintegrants, optionally wet or dry granulated and then compacted. In one or more additional process steps a coating of the tablet can optionally be applied with at least one coating agent with drying steps if needed.
(B2) granule (GR):
Processes to prepare GR formulations are: coating, impregnation and extrusion as described in “New developments in crop protection product formulation” by Alan Knowles, in Agrow Reports 2005, chapter 2.2.
The preferred process according to the invention is an impregnation process, where a solution, suspension or emulsion of a herbicide (A) in water or mineral and/or vegetable oils or solvents or mixtures of these components optionally containing auxiliaries, for example binders, emulsifiers, dispersing agents and surfactants, is sprayed onto a carrier (C) in a blender or in a fluidized bed. If necessary, drying steps can be included during or after finalization of the spray-on process. In one or more additional process steps a coating of the granule can optionally be applied with at least one coating agent and with further drying steps if needed.
(B3) tablet (TB):
Tablets (B3) are prepared in the same manner as tablets for direct application (B1).

The present invention particularly relates to a method for weed control in sugar cane plantations (Saccharum ssp.). Sugar cane varieties cultivated for sugar production generally are multi-species hybrids from species within the Saccharum genus such as S. spontaneum, S. officinarum, S. robustum, S. edule, S. barberi and S. sinense. The method for controlling weeds in sugar cane plantations according to the present invention can be practiced in both conventional (non-genetically modified) and genetically modified (GM) sugar cane.

Weeds, which will be controlled by the agrochemical formulation (B) are for example

Urticaceae: Urtica urens

Polygonaceae: Polygonum con volvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifollus, Rumex acetosa

Portulacaceae: Portulaca oleracea

Coyophyllaceae: Stellaria media, Gerastium holosteoides, Cerastium glomeratum, Spergula arvensis, Silene gallica

Aizoaceae: Mollugo verticillata

Chenopodiaceae: Chenopodium album, Chenopodium ambrosioides, Kochia scoparia, Salsola kali, Atriplex spp.

Amaranthaceae: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera phlloxeroides, Alternanthera sessllis, Alternanthera tenella

Papaveraceae: Papaver rhoeas, Argemone mexicana

Brassicaceae: Raphanus raphanistrum, Raphanus sativus, Sinapis arvensis, Capsella bursa pastoris, Brassica juncea, Brassica campestris, Descurainia pinata, Rorippa islandica, Rorippa sylvestris, Thlaspi arvense, Myagrum rugosum, Lepidium virginicum, Coronopus didymus

Capparaceae: Cleome affinis

Fabaceae: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsuta, Indigofera truxillensis, Vigna sinensis

Oxalidaceae: Oxalis corniculata, Oxalis strica, Oxalis oxyptera

Geraniaceae: Geranium carolinense, Erodium cicutarium

Euphorbiaceae: Euphorbia helioscopia, Euphorbia maculata, Euphorbia humistrata, Euphorbia esula, Euphorbia heterophylla, Euphorbia braslliensis, Acalypha australis, Croton glandulosus, Croton lobatus, Phyllanthus corcovadensis, Ricinus communis

Malvaceae: Abutilon theophrasti, Sida rhombiforia, Sida cordifolia, Sida spinosa, Sida glaziovil, Sida santaremnensis, Hibiscus trionum, Anoda cristata, Malvastrum coromandelianum

Sterculiaceae: Waltheria indica

Violaceae: Viola arvensis, Viola tricolor

Cucurbitaceae: Sicyos angulatus, Echinocystis lobata, Momordica charantia

Lythraceae: Lythrum salicaria

Apiaceae: Hydrocotyle sibthorpioides

Sapindaceae: Cardiospermum halicacabum

Primulaceae: Anagallis arvensis

Asclepiadaceae: Asclepias syriaca, Ampelamus albidus

Rubiaceae: Galium aparine, Galium spurium var. echinospermon, Spermacoce latifolia, Richardia brasiliensis, Borreria alata

Convolvulaceae: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia

Boraginaceae: Myosotis arvensis

Lamiaceae: Lamium purpureum, Lamium amplexicaule, Leonotis nepetaefolia, Hyptis suaveolens, Hyptis lophanta, Leonurus sibiricus, Stachys arvensis

Solanaceae: Datura stramonium, Solanum nigrum, Solanum americanum, Solanum ptycanthum, Solanum sarrachoides, Solanum rostratum, Solanum aculeatissimum, Solanum sisymbrilfolium, Solanum carolinense, Physalis angulata, Physalis subglabrata, Nicandra physaloides

Scrophulariaceae: Veronica hederaefolia, Veronica persica, Veronica arvensis

Plantaginaceae: Plantago asiatica

Asteraceae: Xanthium pensylvanicum, Xanthium occidentale, Helianthus annuus, Matricaria chamomilla, Matricaria perforata, Chrysanthemum segetum, Matricaria matricarioides, Arteraisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii Conyza bonariensis, Conyza canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orient.alis, Soliva sessiils

Liliaceae: Allium canadense, Allium vineale

Commelinaceae: Commelina communis, Commelina bengharensis, Commelina erecta

Poaceae: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multillorum, Lolium perenne, Lolium rigidum, Bromus secalinus, Bromus tectorum, Hordeum jubatum, Aegilops cylindrica, Phalaris arundinacea, Phalaris minor, Apera silica-venti, Panicum dichotomiflorum, Panicum texanum, Panicum maximum, Brachiaria platyphylla, Brachiaria ruziziensis, Brachiaria plantaginea. Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, Rottboellia cochinchinensis

Cyperaceae: Cyperus microiria, Cyperus iria, Cyperus odoratus, Cyperus rotundus, Cyperus esculentus, Kyllinga gracillima

Equisetaceae: Equisetum arvense, Equisetum palustre

The agrochemical formulation (B) according to the invention is particularly useful for controlling the following weed species:

Merremia ssp, Ipomoea ssp., Ricinus Communis, Momordica charantia, Mucuna, Digitaria sp, Rottboellia ssp, Brachiaria ssp, Eieusine indica, Panicum ssp, Amaranthus ssp, Euphorbia ssp, Cyperaceas ssp.

### EXPERIMENTAL DATA

The following agrochemical formulations (B) were prepared:

Formulation 1: GR of Imazapic 1.4% (Ammonium Salt)

### Carrier (C1): a) Biodac® 20/50, b) Biodac® 12/20, c) Biodac® 4/10, Kadant USA

### Carrier (C2): d) Liteball® 14/40, Curimbaba, Brasil

56 ml of a 25% imazapic aqueous solution, neutralized with ammonia at pH 7, was sprayed on 924 g of the carrier C1 and C2 and then dried to a final humidity content of up to 2%.

Formulation 1A is a granular formulation comprising 1.4% imazapic (ammonium salt) and Biodac® 20/50 as carrier.

Formulation 2: GR of Imazapic 1.4% (Ammonium Salt)

### Carrier (C3): e) Urea

5 different processes were used to obtain granules containing 1.4% of Imazapic

Process 1: 6 g of a 25% Imazapic aqueous solution was sprayed onto a 100 g Urea and the product was dried in a fluid bed.

Process 2: 0.74 g of Imazapic acid was solubilized in ethanol. This solution was mixed within 50 g of Urea, the ethanol was evaporated and the product obtained was dried in a fluid bed.

Process 3: an ammonia solution was added to 50 g of Urea and 0.74 g of Imazapic acid, adjusting the pH at 10.5, then heating to 60° C. The mixture was stirred until dissolution than cooled to 5° C. and kept at 5° C. for 24 h. After that the product is filtered and dried.

Process 4: Ethanol was added to 50 g of Urea and 0.74 g of Imazapic acid at 60° C. The mixture was stirred until dissolution than cooled to 5° C. and kept at 5° C. for 24 h. After that the product was filtered and dried.

Process 5: 50 g of Urea and 0.74 g of Imazapic acid are mixed until homogeneity.

Formulation 3: GR of Imazapic 1.4% (Ammonium Salt) with Coating

### Carrier (C1): a) Biodac® 20/50, Kadant USA

Coating auxiliary: a) Glycerine, b) Ethylene glycol, c) Polyvinyl alcohol (PVA), d) polyethylene glycol (PEG).

The formulation a) was put in a mixer and a 1% solution of the coating agent was sprayed onto the granules and then dried up to 2% content of water.

Formulation 4: GR of Imazapic 1.4% (Acid) with Coating

An SC formulation based on Imazapic acid was prepared containing block polymer and poly(oxyethylene) tristyrylphenyl ether phosphate

### Carrier (C1): a) Biodac® 20/50, Kadant USA

Coating auxiliary: a) Glycerine, b) Ethylene glycol, c) Polyvinyl alcohol (PVA), d) polyethylene glycol (PEG), e) Acronal® A 107, f) Acronal® DS 5011, g) Poligen®, h) Joncryl® Wax, i) Carnauba wax, j) stearic acid.

10 g of Imazapic acid SC formulation was sprayed on 87 g of the carrier and after 1 g of auxiliary coating was sprayed. The material was dried up to 2% of water content.

Formulation 5: GR of Imazapic 1.4% (Acid) with Coating

An SC formulation based on Imazapic acid was prepared containing ethoxylated fatty alcohol and polyalkoxylated butyl ether.

### Carrier (C1): a) Biodac® 20/50, Kadant USA

Coating auxiliary: a) Glycerine, b) Ethylene glycol, c) Polyvinyl alcohol (PVA), d) polyethylene glycol (PEG), e) Acronal® A 107, f) Acronal® DS 5011, g) Poligen®, h) Joncryl® Wax, i) Carnauba wax, j) stearic acid.

10 g of Imazapic acid SC formulation was sprayed on 87 g of the carrier and after 1 g of auxiliary coating was sprayed on carrier. The material was dried up to 2% of water content.

Formulation 6: GR of Imazapic 2.8% (Ammonium Salt)

### Carrier (C1): a) Biodac® 20/50, b) Biodac® 12/20, Kadant USA

### Carrier (C2): c) Liteball® 14/40, Curimbaba, Brasil

### Carrier (C4): Calcium Carbonate (Limestone), Franklin Minerals, USA

112 ml of a 25% imazapic aqueous solution neutralized with ammonia at pH 6.5 was sprayed on 868 g of the carrier and then dried to a final humidity content of up to 2%

Formulation 7: GR of Imazapic and Hexazinone Mixture (2.5+2.5%)

### Carrier (C1): a) Biodac® 12/20, Kadant USA

An SC formulation containing 5% of Imazapic acid+5% of Hexazinone was prepared using block polymer and poly(oxyethylene) tristyrylphenyl ether phosphate.

105 g of the SC formulation prepared was sprayed on 195 g of the carrier and the material was dried up to content of water<2%.

Formulation 8: GR of Imazapic and Hexazinone Mixture (2.5+2.5%)

### Carrier (C1): a) Biodac® 12/20, Kadant USA

An SC formulation containing 10% of Imazapic acid+10% of Hexazinone was prepared using ethoxylated fatty alcohol and polyalkoxylated butyl ether.

52.5 g of the SC formulation prepared was sprayed on 195 g of the carrier and the material was dried up to content of water<2%.

Formulation 9: GR of Imazapic and Hexazinone Mixture (2.5+2.5%)

### Carrier (C1): a) Biodac® 12/20, Kadant USA

An SC formulation containing 10% of Imazapic ammonium salt+10% of Hexazinone was prepared using block polymer and poly(oxyethylene) tristyrylphenyl ether phosphate.

52.5 g of the SC formulation prepared was sprayed on 195 g of the carrier and the material was dried up to content of water<2%.

Formulation 10: GR of Imazapic and Hexazinone Mixture (2.5+2.5%)

### Carrier (C1): a) Biodac® 12/20, Kadant USA

Product was prepared within two spray steps. First step using 26 g of an SC formulation based on Hexazinone 20%, containing block polymer and poly(oxyethylene) tristyrylphenyl ether phosphate; was sprayed on 195 g of carrier, after that 20 g of a 25% Imazapic aqueous solution (formulation 1) was sprayed on same amount of carrier and the products was dried up to content of water<2%.

Formulation 11: GR of Sulfentrazone 6.6%

### Carrier (C1): a) Biodac® 20/50, b) Biodac® 12/20, c) Biodac® 4/10, Kadant USA

### Carrier (C2): c) Liteball® 14/40, Curimbaba, Brasil

Formulated product was prepared using 1 l of a solution containing 267 ml of Boral® 500 SC, an SC product commercialized in Brazil, based on sulfentrazone technical. This solution was sprayed on 1.693 kg of carrier. The material was dried up to a content of water<2%.

Formulation 11A is a granular formulation comprising 6.6% sulfentrazone and Biodac® 20/50 as carrier.

Formulation 12: GR of Isoxaflutole 1.5%

### Carrier (C1): a) Biodac® 20/50, b) Biodac® 12/20, c) Biodac® 4/10, Kadant USA

### Carrier (C2): c) Liteball® 14/40, Curimbaba, Brasil

A solution of 11 containing 40 g of a WG product containing Isoxaflutole commercialized as Provence® 750 WG, was sprayed on 1.920 kg of carrier. The obtained product was dried until amount of water<2%.

Formulation 12A is a granular formulation comprising 1.5% isoxaflutole and Biodac® 20/50 as carrier.

Formulation 13: GR of Mesotrione 1.2%

### Carrier (C1): a) Biodac® 20/50, b) Biodac® 12/20, c) Biodac® 4/10, Kadant USA

### Carrier (C2): c) Liteball® 14/40, Curimbaba, Brasil

With 59.5 g of commercial product Callisto, an SC based on mesotrione technical, was prepared a 11 solution. This solution was sprayed on carrier and it was dried until the humidity of formulated product is <2%.

Formulation 13A is a granular formulation comprising 1.2% mesotrione and Biodac® 20/50 as carrier.

Formulation 14: GR of Tebuthiuron 10%

### Carrier (C1): a) Biodac® 20/50, b) Biodac® 12/20, c) Biodac® 4/10, Kadant USA

### Carrier (C2): c) Liteball® 14/40, Curimbaba, Brasil

Product was prepared with a spray solution prepared with 452 g of Combine® 500 SC in 1 l solution. This volume was sprayed on 1560 g of carrier and after it was dried until the content of water<2%.

Formulation 14A is a granular formulation comprising 10% tebuthiuron and Biodac® 20/50 as carrier.

Formulation 15: GR of Hexazinone 1.25%

### Carrier (C1): a) Biodac® 20/50, b) Biodac® 12/20, c) Biodac® 4/10, Kadant USA

### Carrier (C2): c) Liteball® 14/40, Curimbaba, Brasil

A 1 l solution was previously prepared containing 30 g of Broker® 750 WG, a commercial product based on Hexazinone technical. This solution was sprayed on 1.927 kg of carrier and then the volume was dried until the content of water<2%.

Formulation 15A is a granular formulation comprising 1.25% hexazinone and Biodac® 20/50 as carrier.

Trial I:

The following agrochemical formulations (B) were tested for efficacy and crop safety under the following conditions:

This trial was run under wet season, without sugarcane straw (the straw from former plants was removed).

Harvest date: 7 Nov. 2012

Application herbicide date: 12 Dec. 2012—sugarcane had 4 or 5 leaves but it was in pre emergence of weeds.

The application was by hand (solid products) and with backpressure (liquid products)

Type of soil: medium sandy

### Trial Materials and Methods

Location: The study was carried out at Sta Matilde Farm, in the city of Dobrada, Sao Paulo state, geographically located at 21 30′ 319″ south latitude and 48° 28′ 638″ west latitude, 646 m above sea level, in a commercial area with sugar cane ratoon (variety CTC 17).
Method: All treatments were applied in initial post emergence of sugar cane, 4 to 6 true leaves of stage of crop development and at total pre-emergence of weeds. Treatments with BAS Formulation 1A (imazapic 1.4% 20/50 mesh) were applied by hand direct on the soil and without water. The treatments with Plateau 70 WG (imazapic, 70%) were effected with backpressure equipment (nozzles TEEJET8002) with a water consumption of 150 liters per hectare.
Harvest date: 7 Nov. 2012
Installation date: herbicide was applied at 12 Dec. 2012, in pre emergence of weeds, during the wet season, without sugar cane straw (the straw from former plants were removed)
Experimental design: Treatments were located at an experimental design of randomized complete blocks with three repetitions. Each plot consisted 3 meters width and 3 meters length, which equals 9 m² per plot and 27 m² per treatment.
Assessment and assessed criteria: With 65 and 90 days after application were done the evaluations, measuring the control level of weeds and the Phytox level in the crop. Three weeds species were evaluated: BRAPL (Brachiaria plantaginea), CYPRO (Cyperus rotundus) and IPOSS (Ipomoea sp.). The assessment consisted in a visual control level of weeds (0-100%) and a visual crop injury level (0-100%) in the sugar cane.
Data analysis: An analysis was carried out for viability rates applied through a variance analysis and a mean comparison test of Tukey 0.05 with the ARM® statistical analysis package.

### Results:

TABLE 1

| | | phytotoxicity (65 DAT*) | | | | phytotoxicity (95 DAT*) | | | |
|---|---|---|---|---|---|---|---|---|---|
| | g/ha | sugar | | | | sugar | | | |
| treatment | a.i. | cane | CYPRO | BRAPL | IPOSS | cane | CYPRO | BRAPL | IPOSS |
| Form. 1A | 168 | 13 | 98 | 78 | 89 | 11 | 93 | 50 | 82 |
| Form. 1A | 210 | 16 | 99 | 82 | 88 | 16 | 95 | 52 | 76 |
| Form. 1A | 245 | 20 | 99 | 66 | 94 | 23 | 92 | 55 | 94 |
| comp. | 168 | 40 | 99 | 54 | 83 | 40 | 93 | 15 | 77 |
| ex. | | | | | | | | | |
| comp. | 245 | 53 | 99 | 85 | 98 | 57 | 93 | 71 | 97 |
| ex. | | | | | | | | | |

a.i.: active ingredient;
sugar cane: variety CTC 17
Formulation 1A is a granular formulation comprising 1.4% imazapic (ammonium salt) and Biodac ® 20/50 as carrier.
Comparative example is Plateau 70 WG ®, a commercial product from BASF. Plteau 70 WG ® is a wettable granule formulation (WG), comprising 70% imazapic, which is dissolved in water before spray application.
DAT: days after treatment

The formulations according to the invention show improved crop selectivity and weed control in comparison to the standard treatment.

Trial II:

Location: The study was carried out at Sao Jorge Farm, in the city of Atalaia, Parana state, geographically located at 23°11′14.59″S latitude and 52°07′59.01″W longitude, 532 m above the sea level with the RB 867515 variety of Sugar Cane.
Methods: All treatments were applied post emergence of Sugar Cane, 4 true leaves. The inventive granular formulations were applied by hand directly on the soil without water. The comparative treatments (Plateau 70 WG; Boral 500 SC; Provence 750 WG; Callisto SC; Combine 500 SC; Broker 750 WG) were applied with backpressure equipment (Nozzles XR-110.02) with a water consumption of 200 liters per hectare.
The herbicides were applied at Jun. 23, 2014, in post-emergence, when the relative humidity was 65%.
Experimental Design: Treatments were located at an experimental design of complete randomized blocks with 4 repetitions. Each plot consisted 4.8 meter width and 5 meters length, excluding 0.5 m at the edges, which equals 15.7 m² per plot and 62.8 m² per treatment.
Assessment and Assessed Criteria: With 14, 21, and 28 days after application (DAT) were done the evaluations to measure the phytotoxicity level in the crops by visual scale. 28 days after application, stunting and plant height were evaluated too as a phytotoxicity evidence.
Data Analysis: Analysis was carried out for viability rates applied through a variance analysis and a mean comparison test of Scott-Knott, with 5% of relevance.

### Results:

TABLE 2
Percentage of phytotoxicity* after the application
of different herbicide formulations in Sugar Cane,
post-emergence (sandy soil). Atalaia - PR - 2014.

| treatment | a.i. - | a.i. - | phytotoxicity [%] | | |
|---|---|---|---|---|---|
| (formulation) | common name | [g/ha] | 14 DAT | 21 DAT | 28 DAT |
| control-without | — | — | 0 | 0 | 0 |
| herbicide | | | | | |
| control-hand | — | | 0 | 0 | 0 |
| weeded | | | | | |
| Plateau 70 WG | imazapic | 168 | 34 | 45 | 43 |
| 1A | imazapic | 168 | 19 | 24 | 23 |
| Boral 500 SC | sulfentrazone | 800 | 48 | 36 | 35 |
| 11A | sulfentrazone | 800 | 24 | 23 | 29 |
| Provence 750 WG | isoxaflutole | 180 | 48 | 56 | 48 |
| 12A | isoxaflutole | 180 | 28 | 40 | 45 |
| Callisto SC | mesotrione | 144 | 34 | 31 | 25 |
| 13A | mesotrione | 144 | 16 | 19 | 24 |
| Combine 500 SC | tebuthiuron | 1200 | 26 | 28 | 21 |
| 14A | tebuthiuron | 1200 | 16 | 25 | 23 |
| Broker 750 WG | hexazinone | 150 | 23 | 38 | 23 |
| 15A | hexazinone | 150 | 10 | 16 | 25 |

*sugar cane: variety RB 867515;
a.i.: active ingredient;
Formulation 11A is a granular formulation comprising 6.6% sulfentrazone and Biodac ® 20/50 as carrier.
Formulation 12A is a granular formulation comprising 1.5% isoxaflutole and Biodac ® 20/50 as carrier.
Formulation 13A is a granular formulation comprising 1.2% mesotrione and Biodac ® 20/50 as carrier.
Formulation 14A is a granular formulation comprising 10% tebuthiuron and Biodac ® 20/50 as carrier.
Formulation 15A is a granular formulation comprising 1.25% hexazinone and Biodac ® 20/50 as carrier.

### COMPARATIVE EXAMPLES

Plateau 70 WG®, a wettable granule formulation (WG), comprising 70% imazapic, which is dissolved in water before spray application.
Boral 500 SC, a suspension concentrate, comprising, 500 g/l sulfentrazone.
Provence 750 WG, a wettable granule formulation, comprising 750 g/kg isoxaflutole. Callisto 480 SC, a suspension concentrate, comprising 480 g/l mesotrione.
Combine 500 SC, a suspension concentrate, comprising 500 g/l tebuthiuron.
Broker 750 WG, a wettable granule formulation, comprising 750 g/kg hexazinione.
The inventive granular formulations showed reduced Sugar Cane phytotoxicity at 14, 21 and 28 DAT in comparison to conventional formulations applying the same amount of active ingredient.

1-27. (canceled)

28. A method for controlling weeds in sugar cane plantations, wherein at least one herbicide (A) is applied as solid agrochemical formulation (B) to the plantation.

29. The method of claim 28, wherein the agrochemical formulation (B) is applied at the time of harvest of the sugar cane.

30. The method of claim 29, wherein the agrochemical formulation (B) is applied simultaneously with the cutting of the sugar cane stems.

31. The method of claim 29, wherein the agrochemical formulation (B) is applied after the cutting of the sugar cane stems up to the emergence of 10 to 12 leaves from the ratoons.

32. The method of claim 29, wherein the agrochemical formulation (B) is applied after the cutting of the sugar cane stems up to the emergence of 4 leaves from the ratoons.

33. The method of claim 28, wherein at least one herbicide (A) is selected from the following groups:
(A1) imidazolinones selected from the group consisting of imazamox, imazapic, imazapyr, imazaquin and imazethapyr;
(A2) PPO inhibitors selected from the group consisting of saflufenacil, sulfentrazone, flumioxazin, fomesafen, oxadiazon, oxyfluorfen, carfentrazone-ethyl and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4);
(A3) bleacher herbicides selected from the group consisting of isoxaflutole, topramezone, mesotrione, fenquintrione, bicyclopyrone and clomazone;
(A4) photosynthesis inhibitors selected from the group consisting of atrazine, ametryn, terbutryn, simazine, terbutylazine, bentazone, hexazinone, amicarbazone, metribuzin, bromacil, ioxynil, tebuthiuron, diuron, linuron, isouron, diquat and paraquat;
(A5) auxin herbicides selected from 2,4-D, 2,4-DB, MCPA, picloram, dicamba, triclopyr, fluroxypyr, halauxifen and aminopyralid;
(A6) VLCFA inhibitors selected from the group consisting of metolachlor, (S)-metolachlor, dimethenamide, dimethenamide-P, acetochlor, alachlor and pyroxasulfone;
(A7) sulfonylurea herbicides selected from the group consisting of ethoxysulfuron, trifloxysulfuron, sulfometuron, metsulfuron, halosulfuron, iodosulfuron and chlorimuron;
(A8) ACCase inhibitors selected from the group consisting of clethodim, cycloxydim, sethoxydim, profoxydim, tepraloxydim, fluazifop, fluazifop-P, haloxyfop and haloxyfop-P;
(A9) other herbicides such as glyphosate, glufosinate, pendimethalin, trifluralin, diclosulam, asulam, MSMA, TCA and indaziflam;
and the agronomically suitable salts, amides and esters of the herbicides (A1), (A2), (A3), (A4), (A5), (A6), (A7), (A8) and (A9).

34. The method of claim 28, wherein at least one herbicide (A) is selected from the group consisting of metribuzin, diuron, bentazone, hexazinone, tebuthiuron, sulfentrazone, imazapic, imazapyr, glyphosate, MSMA, ametryn, clomazone, isoxaflutole, mesotrione, amicarbazone, atrazine, paraquat, 2,4-D, pendimethalin, saflufenacil and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4).

35. The method of claim 28, wherein the herbicide (A) is imazapic.

36. The method of claim 28, wherein the herbicide (A) is a mixture of imazapic and hexazinone.

37. The method of claim 28, wherein the herbicide (A) is a mixture of imazapic and saflufenacil.

38. The method of claim 28, wherein the herbicide (A) is a mixture of imazapic, hexazinone and saflufenacil.

39. The method of claim 28, wherein the agrochemical formulation (B) is in form of the formulation types (B1) to (B3):
(B1) tablet for direct application (DT),
(B2) granule (GR) and
(B3) tablet (TB).

40. The method of claim 28, wherein the agrochemical formulation (B) is a granular formulation (GR).

41. The method of claim 28, wherein the agrochemical formulation (B) comprises an inert carrier (C).

42. The method of claim 41, wherein the agrochemical formulation (B) comprises a cellulose based carrier.

43. The method of claim 41, wherein the carrier has a particle size distribution of 4 to 50 mesh.

44. The method of claim 41, wherein the carrier has a particle size distribution of 20 to 50 mesh.

45. The method of claim 28, wherein the agrochemical formulation comprises a fertilizer.

46. The method of claim 28, wherein the agrochemical formulation (B) comprises 0.1 to 50% (w/w) of at least one herbicide (A).

47. The method of claim 28, wherein the agrochemical formulation (B) comprises 0.1 to 25% (w/w) of at least one herbicide (A).

48. A solid agrochemical formulation (B), which is a dry, ready for use granule, comprising at least one herbicide (A) selected from the group consisting of metribuzin, diuron, bentazone, hexazinone, tebuthiuron, sulfentrazone, imazapic, imazapyr, glyphosate, MSMA, ametryn, clomazone, isoxaflutole, mesotrione, amicarbazone, atrazine, paraquat, 2,4-D, pendimethalin, saflufenacil and 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione (CAS 1258836-72-4) and at least one carrier (C) selected from the groups (C1) to (C7):
(C1) organic based materials (botanicals);
(C2) fertilizers;
(C3) clays;
(C4) carbonates;
(C5) sulfates;
(C6) synthetic of synthetically modified minerals;
(C7) synthetic polymers, polymer dispersions and superabsorbent polymers.

49. The formulation (B) of claim 48, comprising a clay based carrier.

50. The formulation (B) of claim 48, comprising a cellulose based carrier.

51. The formulation (B) of claim 48, comprising a fertilizer.

52. The formulation (B) of claim 48, comprising an acrylate polymer based coating.

53. A method of preparing the formulation (B) of claim 48, wherein at least one herbicide (A), a carrier (C), optionally a fertilizer and optionally further auxiliaries, are mixed, optionally applying a coating.
